(19) United States
(12) Patent Application Publication
(10) Pub. No.: US 2020/0134668 A1
(43) Pub. Date: Apr. 30, 2020

(54) SYSTEM AND METHOD FOR ESTABLISHING RELATIONAL DATA

(71) Applicant: Institute For Information Industry, Taipei (TW)

(72) Inventors: Cheng-Che HSIEH, Tainan City (TW); Hsiao-Chen CHANG, Taipei City (TW); Jing-Ming CHIU, Taipei City (TW)

(21) Appl. No.: 16/198,734

(22) Filed: Nov. 21, 2018

(30) Foreign Application Priority Data
Oct. 25, 2018 (TW) 107137787

(51) Int. Cl. G06Q 30/02; G06K 9/00; G06N 20/00

(52) U.S. Cl. CPC G06Q 30/0261; G06N 20/00; G06Q 30/0267; G06K 9/00335

(57) ABSTRACT

A method for establishing relational data includes: providing, by a positioning system, user device identity data, user device location data, and user device time data of a user device; capturing, by a camera, an image corresponding to type-of-product data, image location data, and image time data; identifying, by the computer device, a human activity of a person in the image; and producing, by the computer device, relational data for associating the user device identity data and the type-of-product data according to the human activity of the person, the user device identity data, the user device location data, the user device time data, the type-of-product data, the image location data, and the image time data.

### PRIORITY

This application claims priority to Taiwan Patent Application No. 107137787 filed on Oct. 25, 2018, which is hereby incorporated by reference in its entirety.

### FIELD

Embodiments of the present invention relate to a system and method for establishing relational data. More particularly, the embodiments of the present invention relate to a system and method for establishing relational data for Electronic Marketing (E-Marketing).

### BACKGROUND

E-Marketing is an important marketing method in business activities nowadays. On the Internet, merchants may transmit promotional messages to consumers by using various media. For example, the merchants may use emails to transmit advertisements of products, use mobile device applications to transmit promotional messages of products, and/or use webpage browsers to display advertisements of products.

In the case where the identity of a consumer is unknown and the consumer does not provide the information of interested goods, the merchants often hardly provide accurate E-Marketing notifications to consumers according to their preferences. Under the circumstances, the merchants may only transmit a large amount of various E-Marketing notifications to non-specific consumers, and such E-Marketing notifications often fail to reach positive marketing purposes because most of them are not necessary for the consumers who are just interesting in specific types of products. In other words, traditional E-Marketing ways always transmits a large amount of unnecessary marketing notifications and are unable to provide accurate marketing notifications.

In view of this, it is import in the art as to how to effectively establish the relational data for associating products and consumers' preference, especially when the consumers do not log in a specific system or an application of a mobile phone, thereby reducing the amount of transmitting E-Marketing notifications and increasing the accuracy of the E-Marketing notifications.

### SUMMARY

Provided is a system for establishing relational data. The system for establishing relational data may comprise a positioning system, a camera, and a computer device, and the computer device is connected to the positioning system and the camera. The positioning system may be configured to provide user device identity data, user device location data, and user device time data of a user device. The camera may be configured to capture an image which corresponds to type-of-product data, image location data, and image time data. The computer device may be configured to: obtain the user device identity data, the user device location data, the user device time data, the image, the type-of-product data, the image location data, and the image time data; identify a human activity of a person in the image; and produce relational data for associating the user device identity data and the type-of-product data according to the human activity of the person, the user device identity data, the user device location data, the user device time data, the type-of-product data, the image location data, and the image time data.

Also provided is a method for establishing relational data, which may comprise the following steps: providing, by a positioning system, user device identity data, user device location data, and user device time data of a user device; capturing, by a camera, an image which corresponds to type-of-product data, image location data, and image time data; obtaining, by a computer device, the user device identity data, the user device location data, the user device time data, the image, the type-of-product data, the image location data, and the image time data; identifying, by the computer device, a human activity of a person in the image; and producing, by the computer device, relational data for associating the user device identity data and the type-of-product data according to the human activity of the person, the user device identity data, the user device location data, the user device time data, the type-of-product data, the image location data, and the image time data.

The proposed system and method for establishing relational data can establish a relationship between the user device identity data of a user device used of a certain person and a specific type-of-product data according to a human activity of the person (for example, a human activity of purchasing products), and thus generate a relational data. With the relational data, merchants may transmit marketing notifications satisfying the person's preference to the user device, thereby effectively improving the accuracy of the marketing notification and avoiding unnecessary message transmission.

What described above is not intended to limit the present invention, but only generally describes the technical problem that can be solved by the present invention, the technical means that can be adopted and the technical effect that can be achieved so that a person having ordinary skill in the art can preliminarily understand the present invention. Details of the embodiments of the present invention can be further understood by a person having ordinary skill in the art according to attached drawings and contents recorded in the following description of the preferred embodiments.

### BRIEF DESCRIPTION OF THE DRAWINGS

FIG. 1 illustrates a schematic view of a system for establishing relational data according to some embodiments.

FIG. 2 illustrates a schematic view of the operation of the system for establishing relational data of FIG. 1 according to some embodiments.

FIG. 3 illustrates a schematic view of a method for establishing relational data according to some embodiments.

### DETAILED DESCRIPTION

The present invention will be described hereinafter with reference to certain example embodiments thereof. However, these example embodiments are not intended to limit the present invention to only certain embodiments, examples, operations, environment, applications, structures, processes or steps described in these example embodiments.

In the attached drawings, elements unrelated to the present invention are omitted from depiction, but may be implied by the attached drawings, and dimensions of elements and proportional relationships among individual elements in the attached drawings are only exemplary examples but not intended to limit the present invention. Unless stated particularly, same (or similar) element symbols may correspond to same (or similar) elements in the following description. Unless stated specifically, the number of each element described hereinafter may be one or more while it can be implemented.

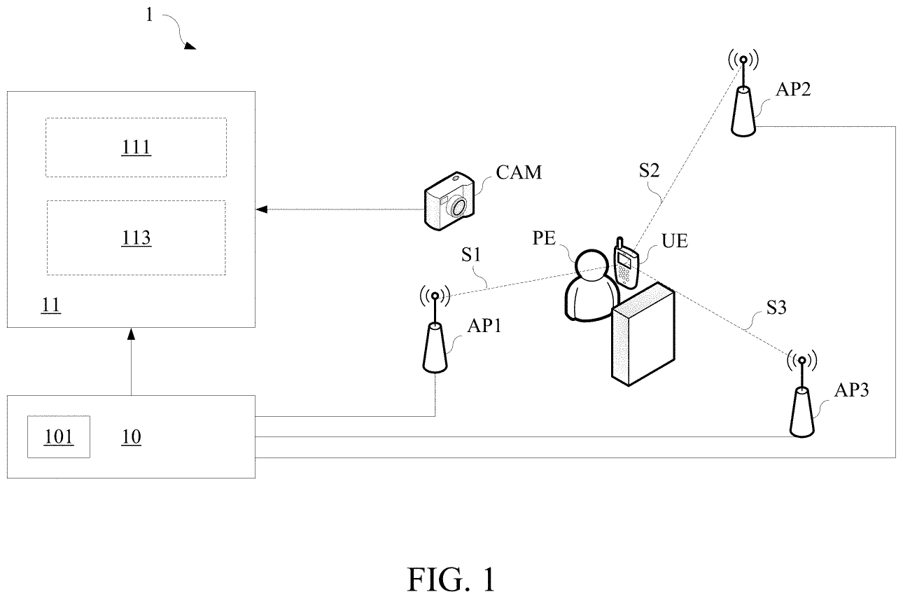

FIG. 1 illustrates a schematic view of a system for establishing relational data according to some embodiments. Contents shown in FIG. 1 are only for illustrating embodiments of the present invention rather than for limiting the present invention. Referring to FIG. 1, a system 1 for establishing relational data may basically comprise a positioning system 10, a camera CAM, and a computer device 11, wherein the computer device 11 is connected to the positioning system 10 and the camera CAM respectively.

The positioning system 10 may comprise a positioning server 101 and three wireless access points AP1, AP2, and AP3. In some embodiments, each of the three wireless access points AP1, AP2, and AP3 may use wireless signals (such as, but not limited to, wireless network signals, infrared signals, Bluetooth signals, etc.) to communicate to user device UE. For example, each of the three wireless access points AP1, AP2, and AP3 may be a Wi-Fi access point and communicate with the user device UE under the Wi-Fi communication architecture. Each of the three wireless access points AP1, AP2, and AP3 may comprise a wired connector or a wireless connector to connect to the positioning server 101 in a wired or wireless manner. In addition, the positioning server 101 may comprise a wired connector or a wireless connector to be connected to the computer device 11 in a wired or wireless manner. The positioning server 101 is a computer device having functions of calculation, storage, transmission, networking, and the like.

The camera CAM may be various devices having functions of dynamically capturing images and/or statically capturing images. For example, the camera CAM may be but not limited to: digital cameras, video recorders, or various mobile devices having photography functions. In addition, the camera CAM may comprise a wired connector and/or a wireless connector to be connected to the computer device 11 in a wired or wireless manner.

The computer device 11 may comprise various processing units (such as a central processing unit, a microprocessor, a microcontroller, etc.) and various storage units (such as a memory, a Universal Serial Bus (USB) disk, a hard disk, a compact disk (CD), flash drive, database, or other storage media or circuits with the same functions). The computer device 11 may perform various logic operations through the processing unit and store the result of the operation into the storage unit. The computer device 11 may be, for example but not limited to, various servers, notebook computers, tablet computers, desktop computers, mobile devices, and the like. The storage unit may store data generated by the computer device 11 itself and various data input to the computer device 11.

The computer device 11 may comprise a wired connector and/or a wireless connector to be connected to the three wireless access points AP1, AP2, and AP3, and the camera CAM in a wired or wireless manner.

Optionally, the computer device 11 may further comprise an interface 111 in some embodiments, and the interface 111 may comprise various input/output elements as those configured in a general computer device/computer for receiving external data from the outside and outputting data to the outside. The interface 111 may comprise, for example but not limited to: a mouse, a trackball, a trackpad, a keyboard, a scanner, a microphone, a user interface, a screen, a touch screen, a projector, and the like. In some embodiments, the interface 111 may comprise a user interface (e.g., a graphical user interface) for the user to interact with the computer device 11.

According to different requirements, the connection relationships mentioned throughout the disclosure may be direct connections (i.e., not connected to each other via other specific functional elements) or indirect connections (i.e., connected to each other via other specific functional elements).

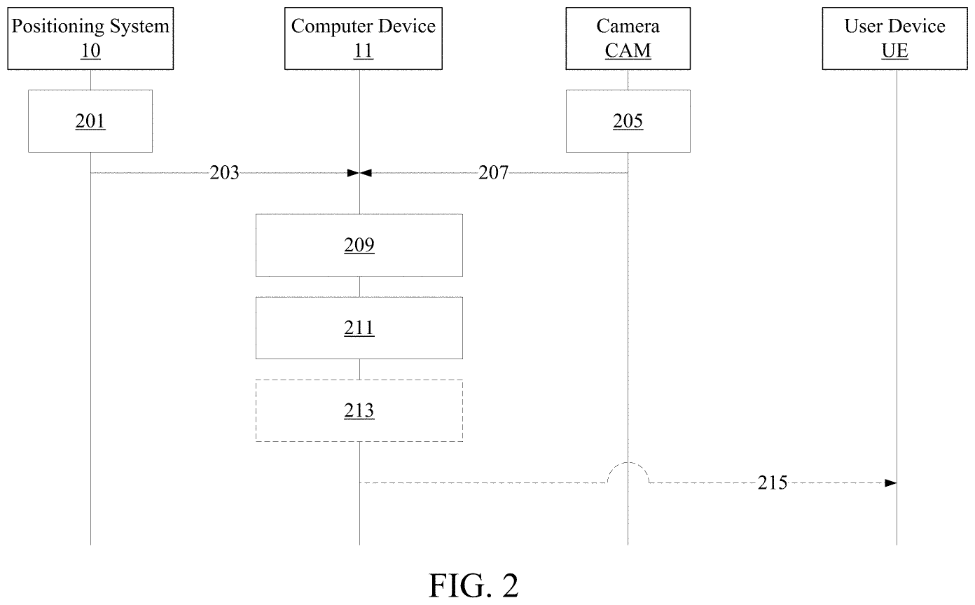

FIG. 2 illustrates a schematic view of the operation of the system 1 for establishing relational data of FIG. 1 according to some embodiments. Contents shown in FIG. 2 are only for illustrating embodiments of the present invention rather than for limiting the present invention.

Referring to both FIG. 1 and FIG. 2, the positioning system 10 may be used to detect the user device UE (shown as 201). More specifically, in the case where the user device UE is located under the signal coverage range of each of the wireless access points AP1, AP2, and AP3, the three wireless access points AP1, AP2, and AP3 can detect the user device UE. For example, in some embodiments where each of the three wireless access points AP1, AP2, and AP3 is a Wi-Fi access point, when the user device UE activates the Wi-Fi searching, each of the three wireless access points AP1, AP2, and AP3 can detect the media access control address (i.e., MAC address) of the user device UE from the packet transmitted by the user device UE, and then transmit the MAC address to the positioning server 101. Also, the positioning server 101 can store the MAC address and generate a timestamp thereof so as to generate the user device identity data and the user device time data of the user device UE. In other embodiments, the three wireless access points AP1, AP2, and AP3 may also detect other types of identity data of the user device UE, and are not limited to the detection of the MAC address described above.

Furthermore, the positioning system 10 may also detect the user device UE by using three wireless access points AP1, AP2, and AP3 according to a triangulation method so as to generate the user device location data. In more detail, each of the three wireless access points AP1, AP2, and AP3 may calculate the distance between the user device UE and itself according to the time required for transmitting messages between them. That is, the distance S1 between the wireless access point AP1 and the user device UE, the distance S2 between the wireless access point AP2 and the user device UE, and the distance S3 between the wireless access point AP3 and the user device UE can be obtained. Each of the three wireless access points AP1, AP2, and AP3 may transmit its respective location data and the calculated distance data to the positioning server 101. Then, the positioning server 101 may calculate the location (i.e., the position) of the user device UE according to the intersection of the circles drawn by the respective distances S1, S2, and S3, thereby generating the user device location data of the user device UE. In a preferred embodiment, the positioning error for the user device UE may be limited within one meter according the positioning information provided by the positioning system 10.

After generating the user device location data, the positioning server 101 may actively or passively transmit the user device identity data of the user device UE, the user device time data, and the user device location data to the computer device 11 (shown as 203).

Referring to both FIG. 1 and FIG. 2, the camera CAM may be configured to capture an image (shown as 205) which corresponds to a type-of-product data, an image location data, and an image time data. Additionally, the camera CAM may be configured to transmit the image the type-of-product data, the image location data, and the image time data to the computer device 11 (shown as 207). The image captured by the camera CAM at least contains a part of a person so as to determine the human activity of the person. The type-of-product data refers to information about the type of products that appear in the image. For example, if the camera CAM captures an image in front of a cabinet in which cosmetics are placed, the type-of-product data corresponding to the image contains information related to the type of the cosmetics. The image location data may comprise information related to the location of the camera CAM itself or to the location faced by the camera CAM (i.e., the actual location of the content of the image). The image time data may comprise a timestamp of each image captured by the camera CAM. In some embodiments, the location of the camera CAM itself and the location captured by the camera CAM are known, and the type of product corresponding to the image captured by the camera CAM is also known. That is, the type-of-product data corresponding to the camera CAM may be established in advance. In this case, the image location data and the type-of-product data may be stored in the computer device 11 in advance.

The computer device 11 may be configured to identify at least one human activity of a person (shown as 209) in the image captured by the camera CAM. For example, if the image captured by the camera CAM comprises all or part of a person PE, the computer device 11 may recognize a human activity of the person PE from the image by a human activity recognition module 113. First, the computer device 11 may use the human activity recognition module 113 to identify whether the person PE in the image appears a human activity of reaching an object (for example, identifying whether the person PE is picking up a certain commodity according to the presentation manner of the arm and hand skeletons of the person PE), a human activity of gazing an object (for example, determining whether the person PE has looked at a certain commodity for a long time according to a plurality of images captured in a continuous period of time), or other human activities of the person PE.

In some embodiments, the computer device 11 may establish and store the human activity recognition module 113 through various machine learning methods in advance. In some embodiments, the human activity recognition module 113 may be pre-established by an external device through various machine learning methods and stored in the computer device 11 in advance. For example, the machine learning methods may be Deep Learning based on a neural network which includes three layers: an input layer, a hidden layer, and an output layer. The input layer is used to receive a plurality of reference image data which may comprise information of the action of at least one hand joint of a person, information of the facing direction of a standing person, and/or information of the skeleton of a person. The output layer is used to produce an expected result which may be but not limited to the action of reaching an object, the gazing range, and the like. By multiple times of learnings, various parameters may be extracted from in the hidden layer, and thus the human activity recognition module 113 may be established based on the extracted parameters.

The computer device 11 may also be configured to generate a relational data for associating the user device identity data and the type-of-product data (shown as 211). In detail, the computer device 11 may compare the user device location data and the image location data, and compare the user device time data and image time data to match the same or similar timestamps if the location difference between the user device location data and the image location data is within a preset range. If the computer device 11 identifies that the person PE in the image presents a preset human activity such as reaching or gazing an object, etc., the computer device 11 establishes a relationship between the user device identity and the type of products corresponding to the image according to the matched timestamps respectively and then generates a relational data according to the relationship. The computer device 11 may also be configured to store all relational data generated.

In some embodiments, the system 1 for establishing relational data may also be configured for marketing related to a certain type of products. For example, the computer device 11 may receive a specified type-of-product corresponding to a certain type-of-product data through the interface 111 (shown as 213). Next, the computer device 11 may obtain the user device identity data corresponding to the type-of-product data according to the specified type-of-product and the stored relational data. Then, the system 1 for establishing relational data may transmit a marketing notification related to the specified type-of-product to the user device UE corresponding to the user device identity data (shown as 215). The marketing notification may comprise, for example but not limited to, a product advertisement message, a product recommendation message, a group purchase notification message, and the like.

In some embodiments, the computer device 11 may transmit the marketing notification to the user device UE through at least one of a mobile device application and a webpage browser. For example, after the person PE downloads a mobile device application related to a certain merchant, the computer device 11 may transmit the marketing notification to the user device UE through the mobile device application. The computer device 11 may also transmit the marketing notification to the user device UE through a webpage browser when the person PE accesses the webpage related to the merchant.

In some embodiments, after receiving a specified type-of-product, the computer device 11 may respectively transmit marketing notifications related to the specified type-of-product to a plurality of related user device UE according to the relational data.

The order in which the operations 201 to 215 shown in FIG. 2 is not limited. The order in which the operations 201 to 215 shown in FIG. 2 may be adjusted in the case while it can still be implemented.

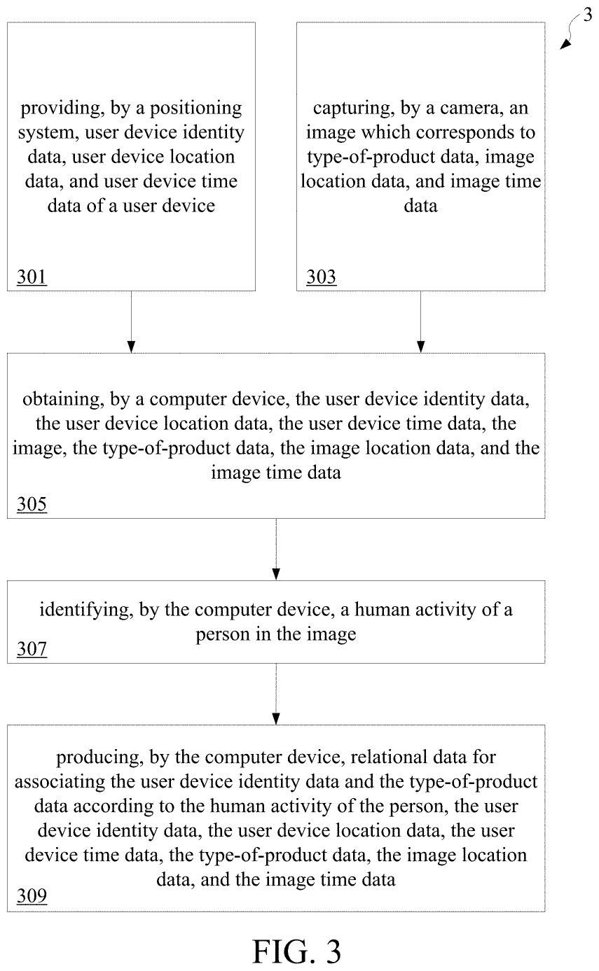

FIG. 3 illustrates a schematic view of a method for establishing relational data according to some embodiments. Contents shown in FIG. 3 are only for illustrating embodiments of the present invention rather than for limiting the present invention.

Referring to FIG. 3, a method 3 for establishing relational data may comprise the following steps:
providing, by a positioning system, user device identity data, user device location data, and user device time data of a user device (shown as step 301);
capturing, by a camera, an image which corresponds to type-of-product data, image location data, and image time data (shown as step 303);
obtaining, by a computer device, the user device identity data, the user device location data, the user device time data, the image, the type-of-product data, the image location data, and the image time data (shown as step 305);
identifying, by the computer device, a human activity of a person in the image (shown as step 307); and
producing, by the computer device, relational data for associating the user device identity data and the type-of-product data according to the human activity of the person, the user device identity data, the user device location data, the user device time data, the type-of-product data, the image location data, and the image time data (shown as step 309).

The order in which the steps 301 to 309 shown in FIG. 3 is not limited. The order in which the steps 301 to 309 shown in FIG. 3 may be adjusted in the case while it can still be implemented.

In some embodiments, the relational data may be produced for marketing related to a type of product corresponding to the type-of-product data.

In some embodiments, the relational data may be produced for marketing related to a type of product corresponding to the type-of-product data. Moreover, in addition to the steps 301 to 309, the method 3 for establishing relational data may further comprise the following steps:
providing, by the computer device, an interface to receive a specified type-of-product corresponding to the type-of-product data;
obtaining, by the computer device, the user device identity data corresponding to the type-of-product data according to the specified type-of-product and the relational data; and
transmitting, by the computer device, a marketing notification related to the specified type-of-product to the user device.

In some embodiments, the relational data may be produced for marketing related to a type of product corresponding to the type-of-product data. Moreover, in addition to steps 301 to 309, the method 3 for establishing relational data may further comprise the following steps:
providing, by the computer device, an interface to receive a specified type-of-product corresponding to the type-of-product data;
obtaining, by the computer device, the user device identity data corresponding to the type-of-product data according to the specified type-of-product and the relational data; and
transmitting, by the computer device, a marketing notification related to the specified type-of-product to the user device through at least one of a mobile device application and a webpage browser.

In some embodiments, in addition to steps 301 to 309, the method 3 for establishing relational data may further comprise the following step: detecting, by the positioning system, the user device by three wireless access points according to a triangulation method. Optionally, each of the three wireless access points may be a Wi-Fi access point.

In some embodiments, the computer device may identify the human activity of the person by a human activity recognition module.

In some embodiments, the computer device may establish the human activity recognition module through machine learning.

In some embodiments, the human activity of the person may comprise at least one of a reaching recognition and a gazing recognition.

In some embodiments, the user device identity data may comprise a media access control address.

In some embodiments, the aforesaid all steps of the method 3 for establishing relational data may be executed by the system 1 for establishing relational data. In addition to the aforesaid steps, the method 3 for establishing relational data may also comprise other steps corresponding to the aforesaid all embodiments of the system 1 for establishing relational data. These other steps can be appreciated by a person having ordinary skill in the art depending on the above description for the system 1 for establishing relational data, and thus will not be further described herein.

The above disclosure is related to the detailed technical contents and inventive features thereof. A person having ordinary skill in the art may proceed with a variety of modifications and replacements according to the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A system for establishing relational data, comprising:
a positioning system, being configured to provide user device identity data, user device location data, and user device time data of a user device;
a camera, being configured to capture an image corresponding to type-of-product data, image location data, and image time data; and
a computer device, being connected to the positioning system and the camera, and being configured to:
obtain the user device identity data, the user device location data, the user device time data, the image, the type-of-product data, the image location data, and the image time data;
identify a human activity of a person in the image; and
produce relational data for associating the user device identity data and the type-of-product data according to the human activity of the person, the user device identity data, the user device location data, the user device time data, the type-of-product data, the image location data, and the image time data.

2. The system for establishing relational data of claim 1, wherein the relational data is produced for marketing related to a type of product corresponding to the type-of-product data.

3. The system for establishing relational data of claim 2, wherein the computer is further configured to:
provide an interface to receive a specified type-of-product corresponding to the type-of-product data;
obtain the user device identity data corresponding to the type-of-product data according to the specified type-of-product and the relational data; and
transmit a marketing notification related to the specified type-of-product to the user device.

4. The system for establishing relational data of claim 3, wherein the computer device transmits the marketing notification through at least one of a mobile device application and a webpage browser.

5. The system for establishing relational data of claim 1, wherein the positioning system comprises three wireless access points, and the positioning system detects the user device by the three wireless access points according to a triangulation method.

6. The system for establishing relational data of claim 1, wherein the computer device identifies the human activity of the person by a human activity recognition module.

7. The system for establishing relational data of claim 6, wherein the computer device establishes the human activity recognition module through machine learning.

8. The system for establishing relational data of claim 1, wherein the human activity of the person comprises at least one of a reaching recognition and a gazing recognition.

9. The system for establishing relational data of claim 5, wherein each of the three wireless access points is a Wi-Fi access point.

10. The system for establishing relational data of claim 1, wherein the user device identity data comprises a media access control address.

11. A method for establishing relational data, comprising:
providing, by a positioning system, user device identity data, user device location data, and user device time data of a user device;
capturing, by a camera, an image corresponding to type-of-product data, image location data, and image time data;
obtaining, by a computer device, the user device identity data, the user device location data, the user device time data, the image, the type-of-product data, the image location data, and the image time data;
identifying, by the computer device, a human activity of a person in the image; and
producing, by the computer device, relational data for associating the user device identity data and the type-of-product data according to the human activity of the person, the user device identity data, the user device location data, the user device time data, the type-of-product data, the image location data, and the image time data.

12. The method for establishing relational data of claim 11, wherein the relational data is produced for marketing related to a type of product corresponding to the type-of-product data.

13. The method for establishing relational data of claim 12, further comprises:
providing, by the computer device, an interface to receive a specified type-of-product corresponding to the type-of-product data;
obtaining, by the computer device, the user device identity data corresponding to the type-of-product data according to the specified type-of-product and the relational data; and
transmitting, by the computer device, a marketing notification related to the specified type-of-product to the user device.

14. The method for establishing relational data of claim 13, wherein the computer device transmits the marketing notification through at least one of a mobile device application and a webpage browser.

15. The method for establishing relational data of claim 11, further comprises:
detecting, by the positioning system, the user device by three wireless access points according to a triangulation method.

16. The method for establishing relational data of claim 11, wherein the computer device identifies the human activity of the person by a human activity recognition module.

17. The method for establishing relational data of claim 16, wherein the computer device establishes the human activity recognition module through machine learning.

18. The method for establishing relational data of claim 11, wherein the human activity of the person comprises at least one of a reaching recognition and a gazing recognition.

19. The method for establishing relational data of claim 15, wherein each of the three wireless access points is a Wi-Fi access point.

20. The method for establishing relational data of claim 11, wherein the user device identity data comprises a media access control address.
